(19) United States
(12) Patent Application Publication
(10) Pub. No.: US 2017/0034389 A1
(43) Pub. Date: Feb. 2, 2017

(54) PRINTING SYSTEM INCORPORATING MULTI-POSITIONAL SENSORS

(71) Applicant: Noel Park, (US)

(72) Inventor: Noel Park, San Jose, CA (US)

(73) Assignee: Noel Park, San Jose, CA (US)

(21) Appl. No.: 15/218,074

(22) Filed: Jul. 24, 2016

Related U.S. Application Data
(60) Provisional application No. 62/197,545, filed on Jul. 27, 2015.

(51) Int. Cl. H04N 1/23; H04N 1/00; H04N 1/387

(52) U.S. Cl. CPC H04N 1/2323; H04N 1/3876; H04N 1/00519; H04N 2201/0082

(57) ABSTRACT

This printing system reproduces an image on various-sized surfaces by means of multi-positional sensors which automatically identify the printers' positions as they move on the surface to be printed. The printing system reproduces the image by selectively firing one or more printers at those positions corresponding to the original image. In case the surface to be printed is larger than one multi-positional sensor frame, the print image is divided into multiple subdivisions whose individual size is slightly smaller than the sensor frame. Upon completing a subdivision, the user moves the sensor frame to the next subdivision and repeats the steps until the entire surface is printed. Printing an image on a large-sized uneven print surface is now possible due to independent printing in any subdivision, free movement of the sensor frame from subdivision to subdivision and independent control of each printer.

### CROSS REFERENCE TO RELATED APPLICATIONS

The present application claims priority from Provisional Patent Application No. 62/197,545 filed on Jul. 27, 2015, which is incorporated herein by reference in their entirety.

### BACKGROUND

After exploring printing options for large surfaces (U.S. Pat. No. 8,291,855, U.S. Pat. No. 7,784,933, U.S. Pat. No. 7,981,462, U.S. Pat. No. 6,832,864, US 7,815,305, U.S. Pat. No. 6,952,284, U.S. Pat. No. 8,125,678), none seemed to be easily manageable, especially on contoured surfaces. This invention attempts to minimize challenges in printing large surfaces allowing for greater ease and speed.

### SUMMARY OF THE INVENTION

This printing system reproduces an image on various-sized surfaces by means of multi-positional sensors which automatically identify the printers' positions as they move on the surface to be printed. The printing system reproduces the image by selectively firing one or more printers at those positions corresponding to the original image.

In the preferred embodiment, the printing system comprises a printing device with one or more printers, multi-positional optical sensors built into a sensor frame, and a computer.

The user creates or uploads an image into the computer, scales the image proportionately to the desired print surface, and stores the print image in the computer. In the computer, the user creates a frame corresponding in scale to the physical sensor frame superimposing the sensor frame image over the print image, thus creating a one-to-one relationship between print image pixels and sensor frame pixels. The user affixes the sensor frame over the print surface with suitable mechanical means according to the framed computer image and places a printing device inside the sensor frame. The sensor frame shape can be rectangular or square and the sensor frame size can range from 1′ by 2′ to 8′ by 10′ although 3′ by 4′ (where ′ represents a foot in measurement) might be the best size for most applications. As the user moves the printing device back and forth across the print surface within the sensor frame, the multi-positional optical sensors track the positions of the printing device. Unlike conventional carriage mechanism, printing is performed in response to an independent position-determining mechanism; therefore, the user's movement of the printing device need not be precise.

Multiple printers are housed to form a single printing device. The multi-positional sensors track the positions of the multiple printers simultaneously. The computer controls each printer in the printing device independently.

In case the surface to be printed is larger than one multi-positional sensor frame, the print image is divided into multiple subdivisions whose individual size is slightly smaller than the sensor frame. The user frames each subdivision image with the sensor frame image in the computer, thus creating individual one-to-one relationships between the each subdivision's print image pixels and the sensor frame pixels. The user identifies the first subdivision location in the print surface and physically affixes the sensor frame to that subdivision location as closely as shown in the computer image, then starts to print. Upon completing the first subdivision, the user moves the sensor frame to the next subdivision and repeats the steps until the entire surface is printed. Printing an image on a large-sized print surface is now possible due to independent printing in any subdivision and free movement of the sensor frame from subdivision to subdivision.

There may be a slight physical misalignment between bit map pixels and sensor pixels when the user moves the sensor frame from one subdivision to the next. The user generates calibration data by comparing the sensor reading of the printing device position before and after the move without moving the printing device. The calibration data comprises linear displacement and angular rotation of the sensor frame. Once the calibration data becomes available, the computer applies the calibration to all print image pixels in a new subdivision.

Printing a large surface is a challenging task. In order to reduce physical demand, a mechanical support for the printing device can be attached to the top of the multi-positional sensor frame. The mechanical support can be motorized or non-motorized and can utilize bars or any other means. In either case, mechanical precision is not required because the printing device position is sensed independently by the multi-positional sensor frame.

Other features and advantages of the present invention will be apparent from the detailed description that follows.

### BRIEF DESCRIPTION OF THE DRAWINGS

Various embodiments of the present invention are illustrated by the accompanying figures, wherein:

FIG. 1 is an illustration of a printing system incorporating multi-positional sensors. The printing system consists of printers within a printing device, multi-positional optical sensors within a frame, and a computer with a screen.

FIG. 2 is an illustration of a printing device, with dual printer, communication links, and a print handle with an activator.

FIG. 3 is a printer with a printing head and a shaft with a printer case. The printer case houses a shaft motor, print materials and a print controller.

FIG. 4 is an inkjet print head for the inkjet printer.

FIG. 5 is an airbrush print head for the airbrush printer.

FIG. 6 is an airbrush print head with proximity sensor.

FIG. 7 is a printer with three shafts.

FIG. 8 is an illustration of multi-positional sensors depicting vertical and horizontal positional sensors.

FIG. 9 is another illustration of multi-positional sensors based on a laser beam.

FIG. 10 is an illustration of a printing device, printing the image within a multi-positional sensor frame.

FIG. 11 is an illustration of a printing device with mechanical supports.

FIG. 12 is an illustration of a printing device with motorized mechanical supports.

FIG. 13 is an illustration of printing system for a contoured print surface, adjusting the length of the shaft with a shaft motor in the printer.

FIG. 14 is an illustration of two printing devices within a multi-positional sensor frame.

FIG. 15 is an illustration of printing initialization when a print surface to be printed is smaller than the sensor frame.

FIG. 16 is an illustration of dividing a surface to be printed into smaller subdivisions when the surface is larger than the sensor frame.

FIG. 17 is an illustration of reading a printing device location by the sensor frame before and after the move without moving the printing device.

FIG. 18 is an illustration of a linear displacement of the sensor frame.

FIG. 19 is an illustration of an angular rotation of the sensor frame.

FIG. 20 is a flow chart for initialization.

FIG. 21 is a flow chart for generating calibration data when the sensor frame moves from one subdivision to the next subdivision.

FIG. 22 is a flow chart for the printing process.

### DETAILED DESCRIPTION OF THE INVENTION

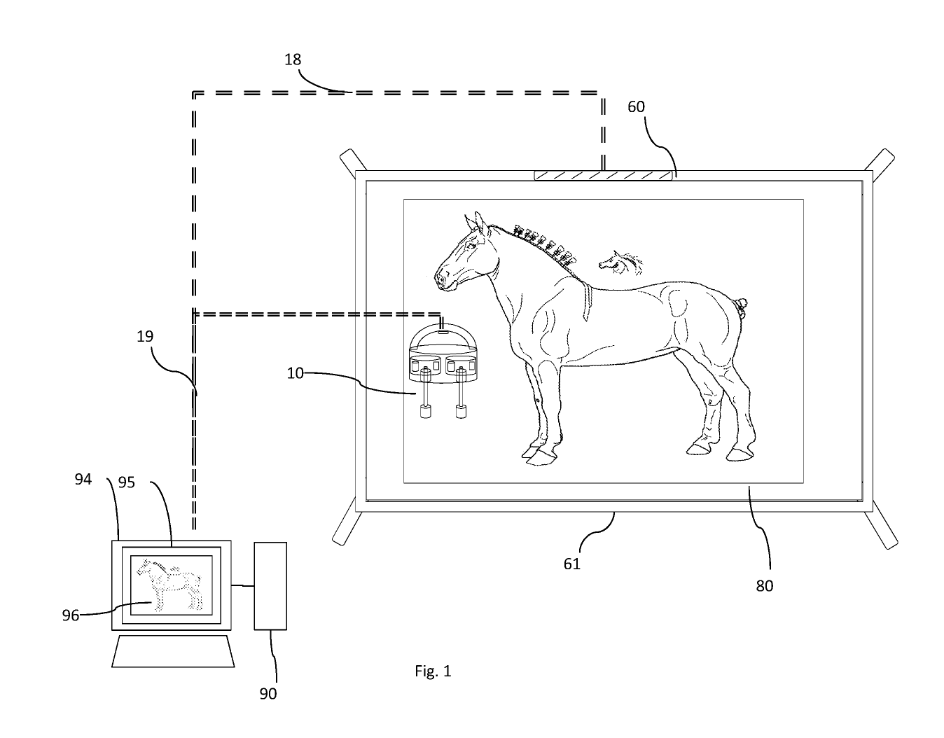

FIG. 1 is an illustration of a printing system incorporating multi-positional sensors 60 within a frame 61. The user uploads or creates an image 96 and scales the image in proportion to the desired print surface 80 storing this information on the computer 90. On the computer 90, the user creates a frame 95 around the image corresponding in scale to the physical sensor frame 61 and stores it to the computer. The user frames the print image 96 with the sensor frame image 95 in the computer screen 94, superimposing the sensor frame image over the print image and thus creating a one-to-one relationship between the print image pixels and sensor frame pixels. The user affixes the physical sensor frame 61 over the surface 80 to be printed according to the computer screen image 94. As the user moves the printing device 10 around, the multi-positional sensors 60 track the positions of the printing device 10. The sensors send the printing device positions to the computer 90 through a communication link 18, wired or wireless. The computer 90 continuously checks the position of the print device 10 and causes the print device 10 to print when the print device is positioned over the image pixels to be printed.

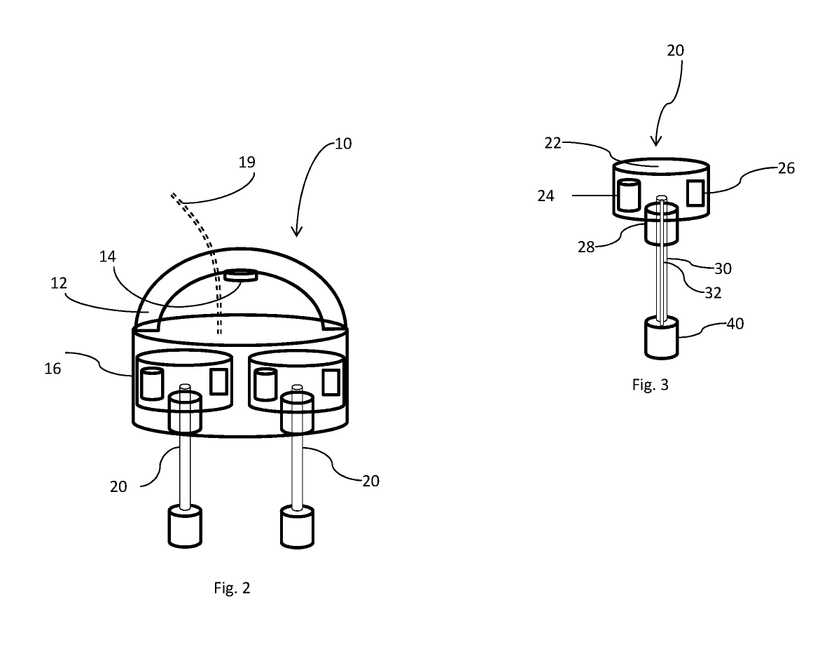

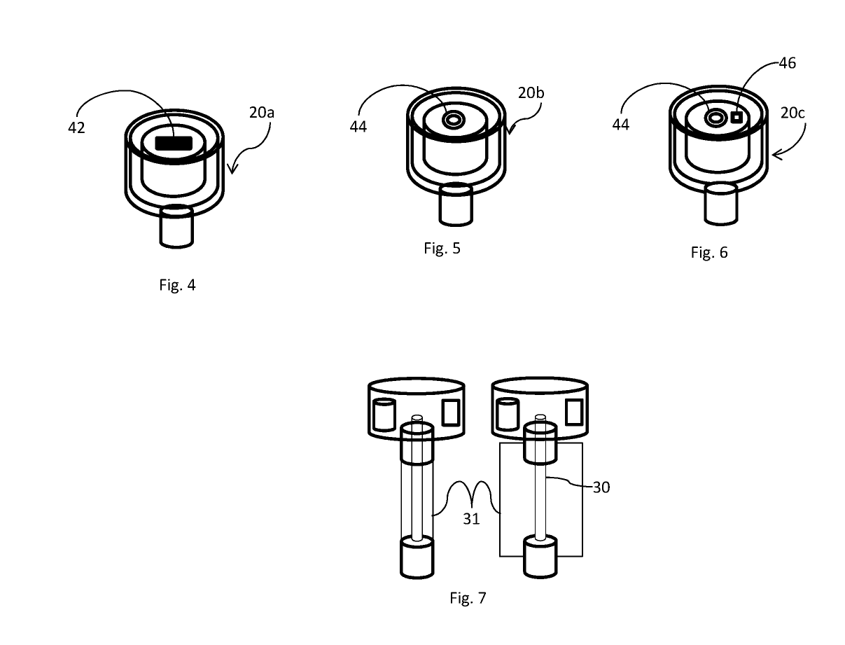

FIG. 2 and FIG. 3 are illustrations of the printing device 10 and a printer 20. The printing device comprises a handle 12 with a manual trigger activator 14 for printing and a printing device house 16 for accommodating one or more printers. Utilizing the handle 12, the user moves the printing device 10 around while keeping the activator 14 on within the physical sensor frame 61. While doing so, the multi-positional sensors 60 detect two shaft 30 positions and make the information available to the computer 90 via the communication link 19. If the computer 90 identifies that the image under the shaft 30 is to be printed, the computer causes the print controller 26 to print. Then, the print controller 26 activates appropriate print elements 42, 44 in the print head to print. At the same time, print material stored in printing material storage 24 is pulled to the print elements 42, 44. A conduit for the print materials and the electrical communication link is built into the shaft core 32 of the printer shaft 30. Each printer 20 has its own independent print controller; therefore, there can be two different printer types. For example, one printer can be inkjet printer type 20a (FIG. 4) while the other one can be airbrush printer type 20b (FIG. 5) or the other one can be an airbrush printer with a proximity sensor of type 20b (FIG. 6). Printer 20 has a printer case 22 housing the print controller 26, the printing material storage 24 and the shaft motor 28. Printer 20 has a shaft 30 attached to a print head 40 on one side and printer case 22 on the other side. The shaft length is controlled by a shaft motor 28 moving the shaft 30 up and down. The changing shaft length is to be used for printing on contoured or uneven surfaces. A proximity sensor 46 built in near the print element 44 detects whether the distance between the print surface 80 and the print head 40 is within a desirable distance and makes those information available to the print controller. The print controller 26 passes that information to the computer. If the computer requests the print controller to change the shaft length, the print controller activates the shaft motor 28 to adjust the shaft length.

FIG. 7 is an illustration of a printer with three shafts. The center shaft 30 is used to hold the print head stable and to become a conduit for the printing material and link wires. The other two side shafts 31 are used to determine the position of the printer. Therefore, the center shaft can be thick and strong and the two side shafts can be thin.

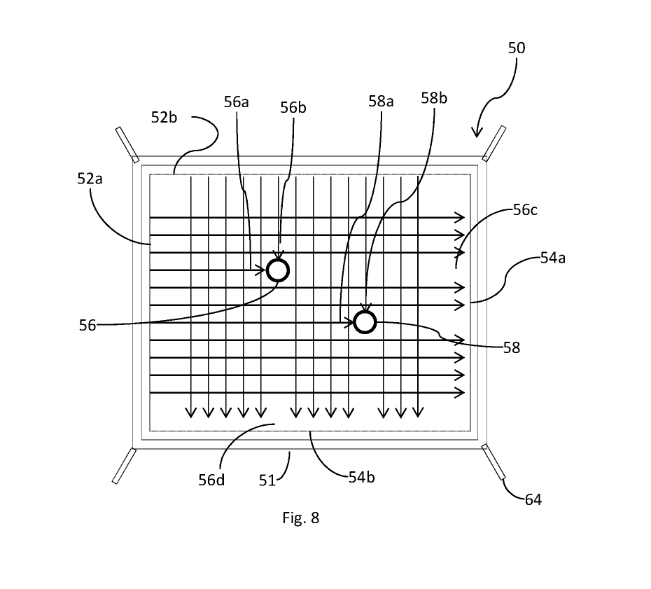

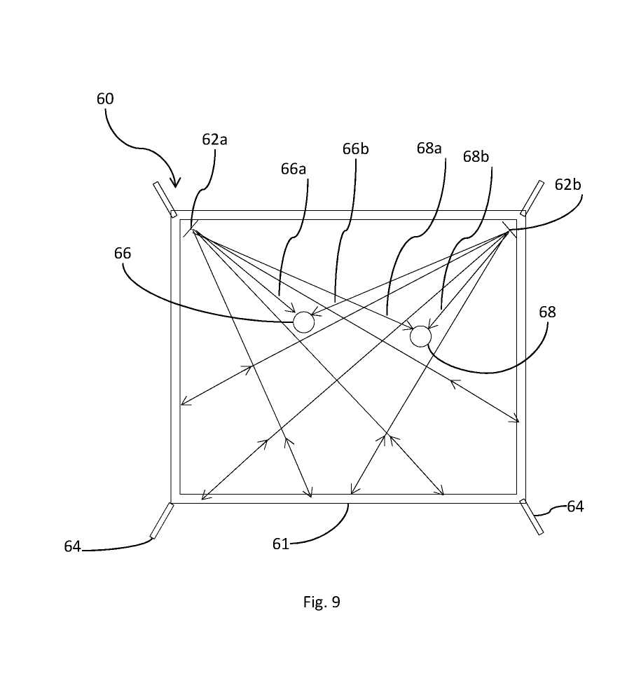

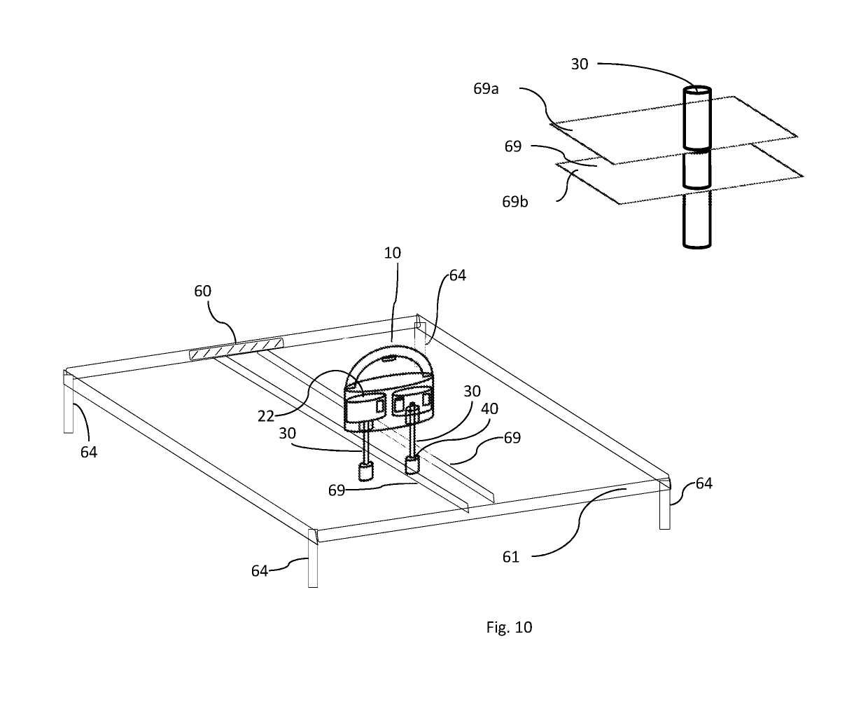

FIG. 8 and FIG. 9 are illustrations of two examples of multi-positional sensors 50, 60 and the sensor frames 51, 61. Although only two examples are shown here, there are a number of multi-positional sensors based on various technologies such as capacitive, inductive, etc. FIG. 8 illustrates a LED array sensor 50 which utilizes the array of LED transmitters 52a, 52b and the array of CMOS light detectors 54a, 54b located on opposite sides. If an object 56 blocks the passage of light 56a, 56b, light detectors 56c, 56d in the detector array 54a, 54b detect the absence of light. The LED array light generators and CMOS detectors are housed in a frame 51.

FIG. 9 is an illustration of another example of multi-positional sensors 60 based on a laser beam. Laser beams are aimed at a rotating mirror 62a and the rotating mirror rotates laser beams, which are reflected back to the mirror locations through a grating pattern embedded in the groove of the frame 61. A receiver at the mirror site receives the reflected beam and measures the absence or presence of the beam which indicates the absence or presence of an object. For example, object 66 blocks the incident beams 66a, 66b. By measuring two incident angles of the beams to the object, the coordinates of object 66 is calculated. The rotating mirrors 62a, 62b and a grating pattern are housed in the groove of the frame 61. For the purpose of illustration, the laser beam position sensors 60 are used throughout the rest of the description. However, other types of sensors are also equally applicable.

FIG. 10 is an illustration of the operation of a printing device 10 within the multi-positional sensor frame 61 with raised legs 64. The multi-positional sensors 60 with laser beam transmitters, receivers as well as the reflectors are built into the sensor frame 61 and establish an optical sensing plane 69. The optical sensing plane has a finite thickness close to the frame thickness and any objects above the top boundary 69a and below the bottom boundary 69b are not detected by the sensors. The print head 40 is generally too big to use as an object; therefore, it is necessary to keep the light sensing plane 69 above the print head 40. The present invention achieves this objective by raising the sensor frame 61, hence the sensing plane 69, with legs 64 above the print head height. The print head 40 and printer case 22 are connected by a shaft 30, which becomes an object to be detected in the light sensing plane 69. The shaft 30 can be designed as thin as possible. Alternatively, two thin side shafts 31 in FIG. 7 can be also used as position detecting shafts. The thinner the shaft, the more precise is the measurement. Due to the fixed physical relationship among the shaft 30, the print head 40, and print elements 42, 44, the shaft position provides the XY coordinates of the print elements 42, 44. The multi-positional sensors 60 continuously detect moving shaft positions and pass the position information to the computer 90. The computer 90 continuously converts the shaft positions to the XY coordinates of each print element 42, 44, and causes the print elements 42, 44 to fire when a print element is over a print image pixel to be printed.

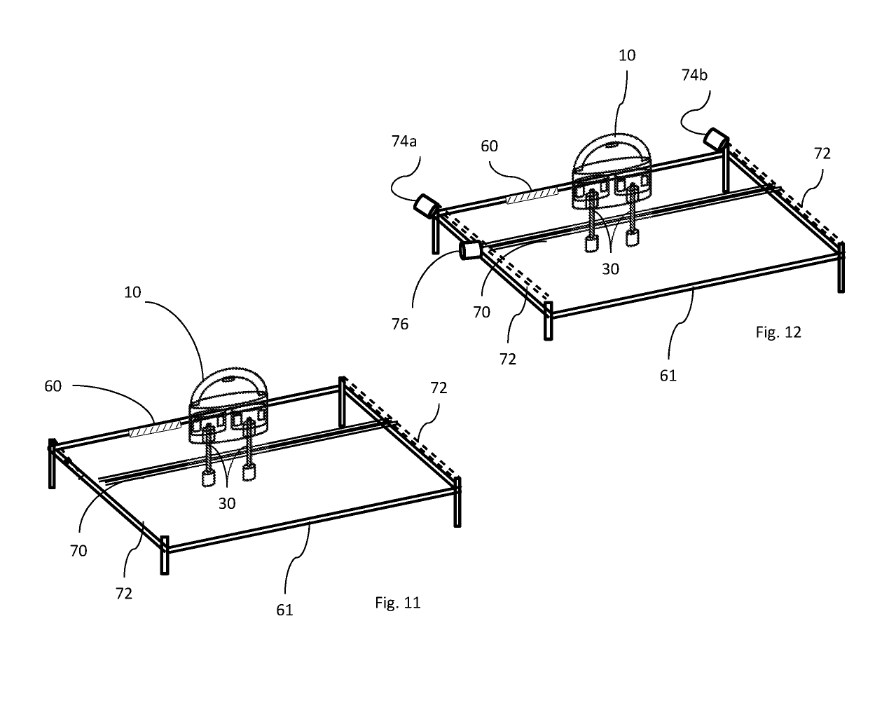

FIG. 11 is an illustration of mechanical supports for a printing device. When the user prints a large surface, the user becomes fatigued after long hours of work. The user rests the printing device 10 on the mechanical supports and moves the print device with ease. The X bar 70 moves along two Y bars 72, which support the X bar at two ends. Y bars 72 are attached to the multi-position sensor frame 61. The print device resting on the X bar easily moves along the X bar 70, thereby allowing for easy movement in both directions.

FIG. 12 is an illustration of motorized mechanical supports for a printing device. A motor is attached to one end of each X and Y bar. The X bar 70 is attached to the Y bars 72 such that when the Y bars are rotated by Y motors 74a, 74b, the X bar moves along the Y bars. Similarly, the print device is attached to the X bar such that when the X bar 70 rotates by X motor 76, the print device 10 moves along the X bar. Although the printing device 10 can be programmed to move randomly, it is preferable to make it move from left to right and top to bottom. Since the printing itself relies on the position sensing of the print device 10, no precision control and components are required. This mechanical support, whether motorized or not, creates a simple and economical print device which can cover large printing areas with minimal manual efforts.

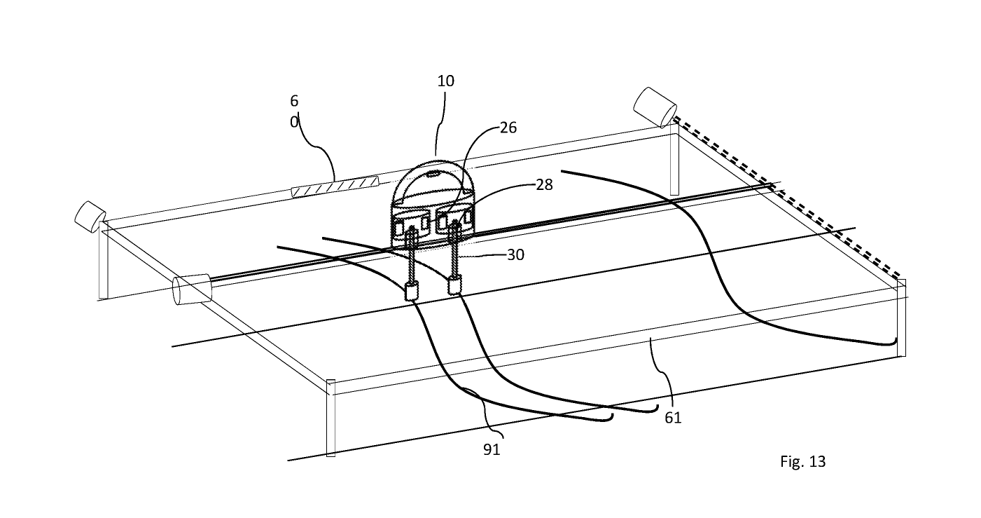

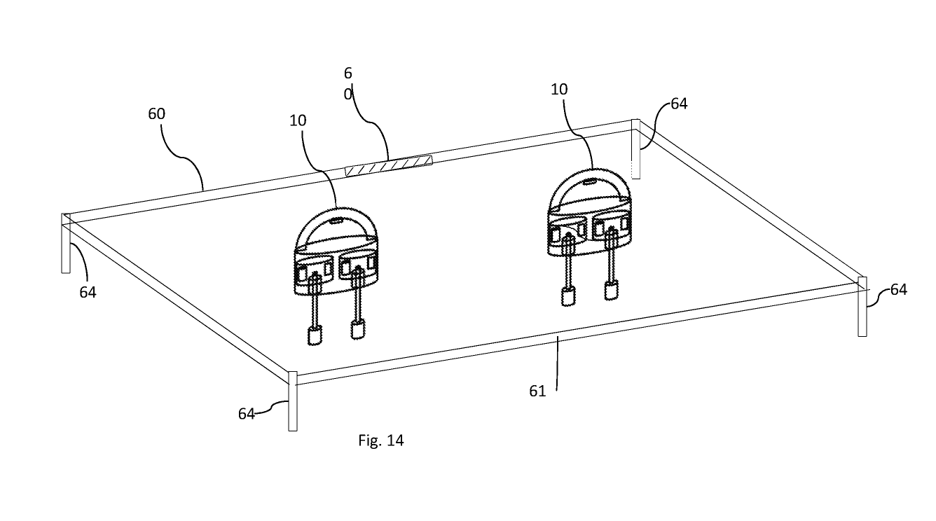

FIG. 13 is an illustration of a motorized printing device covering an uneven print surface 91. A proximity sensor 46 built into the print head 40 detects whether the distance between the contoured surface 91 and the print head 40 is within a desirable distance and makes that information available to the print controller 26. The print controller 26 passes that information to the computer. If the computer 90 requests the print controller to change the shaft 30 length, the print controller 26 activates the shaft motor 28 to adjust the shaft 30 length.

FIG. 14 is an illustration of the operation of a multiple printing device (two printing device in this example). Each printing device 10 works independently such that one user can use two printing devices or two users can work separately.

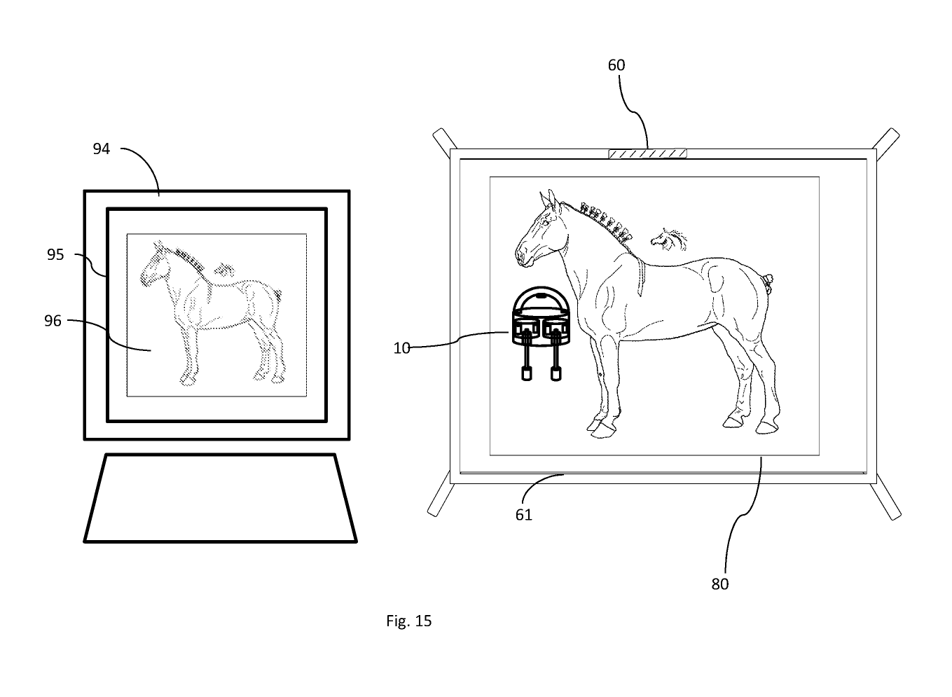

FIG. 15 is an illustration of an initialization of the printing system. A user creates a print image 96 with scale information for the real print surface 90 and stores it to a computer. The user creates a sensor frame image 95 for the physical sensor frame 61 with the same scale used to create the print image 96 and stores it to a computer. The user frames the print image 96 with the sensor frame image 95 in the computer screen 94, superimposing the sensor frame image over the print image, thus creating a one-to-one relationship between the print image pixels and sensor frame pixels. The user affixes the physical sensor frame 61 to a print surface 80 and starts to print by moving the print device 10 freely any direction within the physical sensor frame 61.

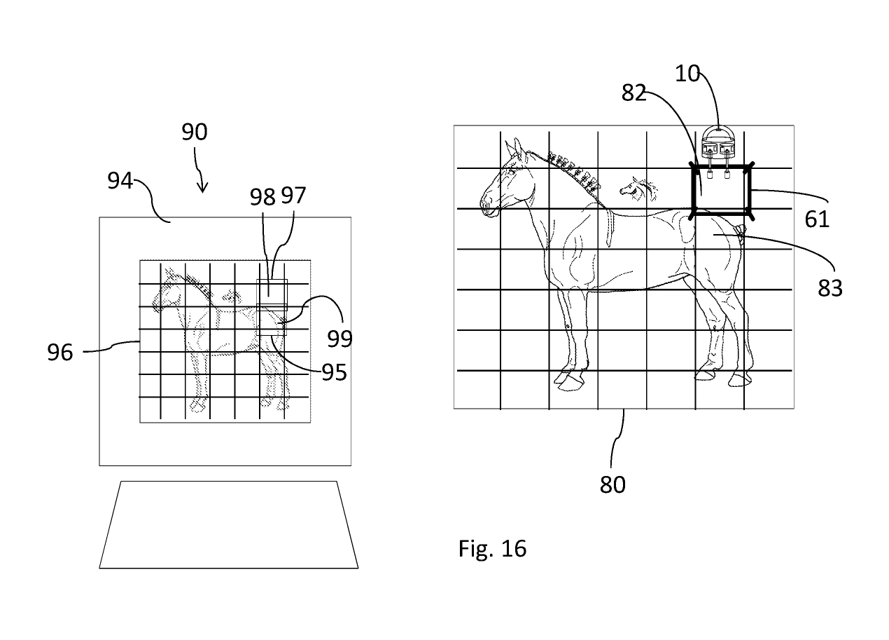

FIG. 16 is an illustration of the printing method when the physical print surface 80 is bigger than the physical sensor frame 61. In the computer, a user divides the print image 96 into multiple subdivisions whose individual size is slightly smaller than the sensor frame image 97. The user selects a subdivision as a starting point, for example, the subdivision 98. The user overlays the sensor frame image 97 over the subdivision 98 image and creates a one-to-one relationship between the sensor frame pixels and subdivision print image pixels. The user affixes the physical multi-positional sensor frame 61 to that subdivision 82 corresponding to the computer subdivision 98. The user moves the print device 10 to this subdivision 82 and starts to print. Upon completing the printing of the subdivision 82, the user moves the multi-positional sensor frame 61 to the next subdivision 83. The user, in the computer 90, creates a new one-to-one relationship between the new subdivision print image pixels 99 and the new location sensor frame pixels 95.

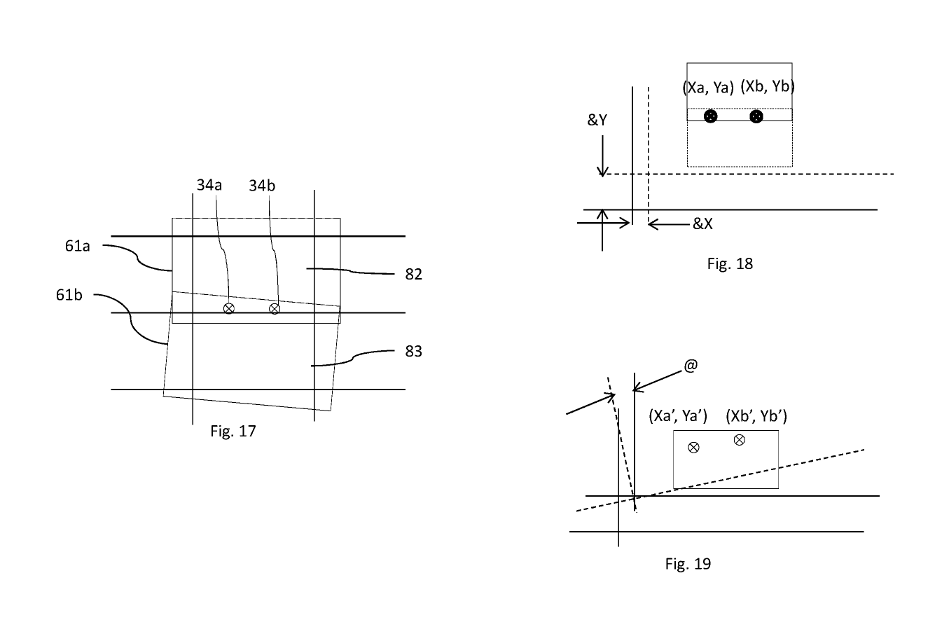

FIG. 17, FIG. 18, and FIG. 19 are illustrations for creating a new one-to-one relationship between sensor pixels and print image pixels after moving the sensor frame. After printing the subdivision 82, the user captures two shaft positions 34a, 34b of the printing device. Without moving the printing device, the user moves the current sensor frame 61a to the next subdivision 83 such that the printing device sits within the moved sensor frame 61b. After the move, the user captures the printing device positions 34a, 34b again. Now the user has two data points for one spot, one from before the move and the other one from after the move. The movement of the sensor frame is decomposed into a linear displacement as shown in FIG. 10b and an angular rotation as shown in FIG. 19.

The mathematical relationships for linear displacements &X, &Y and angular rotation @ between two sensor frame locations in a matrix form are:

$$[ \begin{matrix}{Xa}^{′} \\ {Ya}^{′}\end{matrix} ] = [ \begin{matrix}cos @ , & - sin @ \\ sin @ , & cos @\end{matrix} ] [ \begin{matrix}Xa + \& x \\ Ya + \& y\end{matrix} ] \\ [ \begin{matrix}{Xb}^{′} \\ {Yb}^{′}\end{matrix} ] = [ \begin{matrix}cos @ , & - sin @ \\ sin @ , & cos @\end{matrix} ] [ \begin{matrix}Xb + \& x \\ Yb + \& y\end{matrix} ]$$

Where
1) Xa, Ya are the XY coordinates of point 34a from the sensor frame at the subdivision 82
2) Xb, Yb are the XY coordinates of point 34b from the sensor frame at the subdivision 82
3) Xa′, Ya′ are the XY coordinates of point 34a from the sensor frame at the subdivision 83
4) Xb′, Yb′ are the XY coordinates of point 34b from the sensor frame at the subdivision 83
5) &X is X directional displacement
6) &Y is Y directional displacement
7) @ is an angular rotation

The computer extracts &X, &Y, and @ by solving the above matrix equation.

Once &X, &Y, and @ are extracted, the computer recalculates print image pixel addresses for every pixel in the new subdivision forming a new one-to-one relationship between the print image pixels and the newly moved sensor frame pixels.

Upon completion of the new subdivision 83, the user repeats the steps of moving the sensor frame and calibrating the moved frame for all subdivisions until the entire image is printed. Printing an image on a large-sized print surface is now possible due to independent printing in any subdivision and free movement of the sensor frame from subdivision to subdivision.

Since the computer needs at least two point positions in order to make smooth image printing transition from one subdivision 82 to the next subdivision 83, if there is only one printer 20 in the printing device 10, a three shaft printer 21 is to be used in order to use two side shafts 31 as two positional sensing objects.

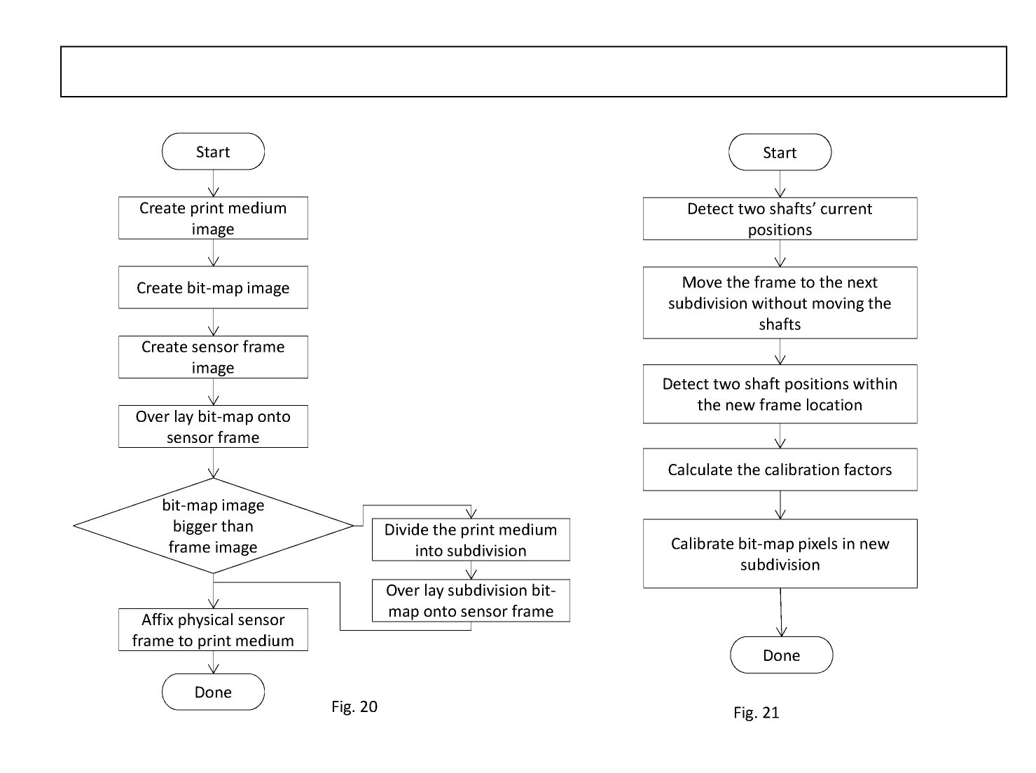

FIG. 20 is the flow chart of the initialization process. A user creates a print image with scale information for the image to be printed and stores it to a computer. The user creates a sensor frame image corresponding in scale to the physical sensor frame and stores it to a computer. The user frames the computerized image with the sensor frame image in the computer, superimposing it over the bit map image and thus creating a one-to-one relationship between the print image pixels and sensor frame pixels. If the print image is bigger than the sensor frame, the image is divided into multiple subdivisions whose individual size is slightly smaller than the sensor frame. The user selects a subdivision as a starting point. The user affixes the physical sensor frame to a print surface and starts to print by moving the print device freely any direction within the physical sensor frame.

FIG. 21 is the flow chart for calibrating the sensor frame pixels against the subdivision image pixels whenever a sensor frame moves from one subdivision to another subdivision. At the end of one subdivision printing, the user captures two printing device positions. With the printing device unmoved, the user physically moves the sensor frame to the next subdivision such that the newly moved sensor frame encloses the unmoved printing device. After the move, the user captures the printing device's two positions again. Now the user has two data collected from one spot; one from before the move and the other one from after the move. With these two sets of data, the user generates calibration factors. The calibration factors comprise linear displacement and angular rotation. Once the calibration factors become available, the computer applies the calibration factors to all print image pixels in a new subdivision.

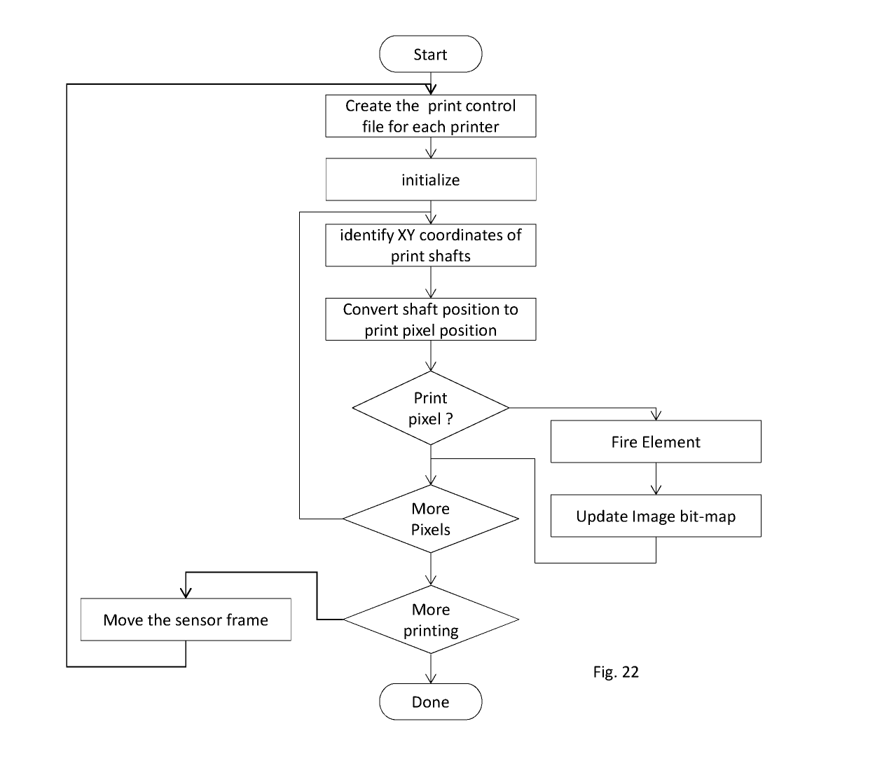

FIG. 22 is a flow chart for the printing process. The user creates an independent print control file specific to each printer and goes through an initialization process. The computer monitors the XY coordinates of the print shafts and converts them to the XY coordinates of the print elements. When the print elements are over the image pixels, the computer causes a print element to print. The computer updates the print image pixels so that one can avoid a double printing. Once all pixels in the sensor frame are printed, the sensor frame is moved to the next position until all printing is done.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

### REFERENCE NUMERALS

10 printing device
12 handle
14 activator
16 printing device house
19 communication link
20 printer
22 printer case
24 printing material storage
26 print controller
28 shaft motor
30, 31 side shaft
32 shaft core
34a, 34b shaft position
42, 44 print element
46 proximity sensor
50 LED array sensors
51 LED sensor frame
52a, 52b LED transmitters
54a, 54b CMOS array receivers
56 object
56a, 56b incident lights for the object 56
56c, 56d blocked lights by the object 56
58 object
58a, 58b incident lights for the object 58
58c, 58d blocked lights by the object 58
60 laser beam sensors
61, 61a sensor frame
62a, 62b rotating mirrors
64 leg
66 object
66a, 66b incident lights for the object 66
66c, 66d blocked lights by the object 66
68 object
68a, 68b incident lights for the object 68
68c, 68d blocked lights by the object 68
69 light sensing plane
69a upper plane boundary
69b lower plane boundary
70 X bar
72 Y bar
76 X bar motor
74a, 74b Y bar motors
80 print surface
82, 83 subdivision
90 computer
94 computer screen
96 print image
95, 97 subdivision sensor frame image
98, 99 subdivision print image

What is claimed:

1. A printing system, comprising:
a frame;
four legs attached to said frame;
a computer;
print devices connected to a computer and mounted on said frame; and
multi-positional sensors mounted to a frame wherein said sensors are connected to said computer through a communications link determine the location of said print devices;

2. The printing system of claim 1, wherein:
Said print device comprising:
a print device housing;
a handle attached to the side of said print device housing;
one or more printers mounted within a print device housing; and
a manual trigger activator is mounted within the handle;

3. The printing system of claim 2, wherein:
Said printer comprising:
a printer case;
a printer controller housed in said printer case;
printing material storage mounted within the printer case;
a printer head;
a proximity sensor mounted near the print head;
a shaft mounted to the printer case on one end and a printer head on the other end; and
a shaft motor within the printer case is mounted onto said shaft.

4. The printing system of claim 3, wherein said printer comprises of three shafts wherein said center shaft is a conduit for printing material and said other two shafts determine the position of said printer.

5. The printing system of claim 3, wherein said computer causes said shaft motor to move said in such a way to maintain an ideal distance from a printing surface.

6. The printer system of claim 3, wherein said printing device is mounted on a mechanical support wherein said mechanical support comprises:
two Y bars; and
a X bar mounted with said printing device in the middle and one end of said X bar attached to said Y bars.

7. The printer system of claim 3, wherein said X bar has a motor attached and said Y bars have a motor attached.

8. A method of printing a large image, comprising:
dividing a print image into multiple subdivisions whose individual size is slightly smaller than a sensor frame image;
overlaying the sensor frame image over a subdivision image;
creating a one-to-one relationship between a sensor frame pixels and a subdivision print image pixels;
affixing a physical multi-positional sensor frame to the subdivision;
printing the subdivision;
detecting two shafts' current positions;
moving the sensor frame to the next subdivision without moving the shafts;
detecting two shaft positions within the new frame location;
calculating the calibration factors;
calibrating bit-map pixels in new subdivision; and
printing the next subdivision.
